(19) United States
(12) Patent Application Publication
(10) Pub. No.: US 2018/0306396 A1
(43) Pub. Date: Oct. 25, 2018

(54) Electric Candle Having Flickering Effect

(71) Applicant: L & L Candle Company, LLC, Eden Prarie, MN (US)

(72) Inventor: Douglas Patton, Irvine, CA (US)

(21) Appl. No.: 15/958,873

(22) Filed: Apr. 20, 2018

Related U.S. Application Data
(60) Provisional application No. 62/487,569, filed on Apr. 20, 2017.

(51) Int. Cl. F21S 10/04; F21S 6/00; F21K 9/238; F21K 9/235; F21V 19/00

(52) U.S. Cl. CPC F21S 10/046; F21S 6/001; F21Y 2115/10; F21K 9/235; F21V 19/0055; F21K 9/238

(57) ABSTRACT

An electronic lighting device and a method for manufacturing the same are disclosed. A housing is formed for the light source support inside the housing. The light source support holds a light source that shines light onto a flame element. The flame element has an upper part shaped like a flame and a lower part extending in the opposite direction from the upper part allowing the flame element to move like a pendulum. The upper part can include a spherical ball that fits into a recess and the housing, and moves back and forth while being illuminated by the light source. In one embodiment, there is a circuit board in the housing, and the light source, as wealth an electromagnet to move the pendulum can both be mounted on the circuit board.

### CROSS REFERENCE TO RELATED APPLICATIONS

The present application claims priority from provisional application No. 62/487,569, filed Apr. 20, 2017, the entire disclosure of which is hereby incorporated by reference in its entirety.

### TECHNICAL FIELD

The field of the invention is electronic lighting devices, and in particular, electric candles.

### BACKGROUND

The background description includes information that may be useful in understanding the present invention. It is not an admission that any of the information provided herein is prior art or relevant to the presently claimed invention, or that any publication specifically or implicitly referenced qualifies as prior art under the law.

Various electric lights are known in the art. See, e.g., U.S. Pat. No. 8,132,936 to Patton et al., U.S. Pat. No. 8,070,319 to Schnuckle et al., U.S. Pat. No. 7,837,355 to Schnuckle et al., U.S. Pat. No. 7,261,455 to Schnuckle et al., U.S. Pat. No. 7,159,994 to Schnuckle et al., US 2011/0127914 to Patton et al., U.S. Pat. No. 7,350,720 to Jaworski et al.; US 2005/0285538 to Jaworski et al. (publ. December 2005); U.S. Pat. No. 7,481,571 to Bistritzky et al.; US 2008/0031784 to Bistritzky et al. (publ. February 2008); US 2006/0125420 to Boone et al. (publ. June 2006); US 2007/0127249 to Medley et al. (publ. June 2007); US 2008/0150453 to Medley et al. (publ. June 2008); US 2005/0169666 to Porchia, et al. (publ. August 2005); U.S. Pat. No. 7,503,668 to Porchia, et al.; U.S. Pat. No. 7,824,627 to Michaels, et al.; US 2006/0039835 to Nottingham et al. (publ. February 2006); US 2008/0038156 to Jaramillo (publ. Feb. 2008); US 2008/0130266 to DeWitt et al. (publ. June 2008); US 2012/0024837 to Thompson (publ. February 2012); US 2011/0134628 to Pestl et al. (publ. June 2011); US 2011/0027124 to Albee et al. (publ. February 2011); US 2012/0020052 to McCavit et al. (publ. January 2012); US 2012/0093491 to Browder et al. (publ. April 2012); and US 2014/0218903 to Sheng.

However, there is still a need in the art for improved electric candles and other lighting devices that generate a flickering flame effect.

### SUMMARY OF THE INVENTION

The present invention provides apparatus, systems, and methods in which an electronic lighting device (e.g., an artificial candle) comprises a structure that helps to simulate a real candle flame, preferably in the look of a traditional candle.

One should appreciate that the disclosed subject matter provides many advantageous technical effects including providing various designs of an artificial candle that simulate a real candle light. Thus, many drawbacks of conventional methods of providing an artificial candle can be reduced, and even possibly eliminated, by the disclosed subject matter.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A-1D are perspective, top, vertical cross-section, and exploded views, respectively, of one embodiment of an electronic lighting device.

FIGS. 2A-2B are top, perspective and bottom, perspective views, respectively of an embodiment of an outer shell of the electronic lighting device shown in FIG. 1A.

FIGS. 3A-3B are top, perspective and bottom, perspective views, respectively of an embodiment of an inner shell of the electronic lighting device shown in FIG. 1A.

FIGS. 4A-4D are top perspective, bottom perspective, first vertical and second vertical cross-section views, respectively, of a housing of the electronic lighting device shown in FIG. 1A.

FIGS. 5A-5C are various exploded views of one embodiment of a pendulum member of the electronic lighting device shown in FIG. 1A.

FIG. 6 is a perspective view of one embodiment of a light source holder and a circuit board of the electronic lighting device shown in FIG. 1A

FIGS. 7A-7D are various cross-section views of a second embodiment of an electronic lighting device.

FIGS. 8A-8B are cross-section views of a third embodiment of an electronic lighting device.

FIG. 9 is a cross-section view of a fourth embodiment of an electronic lighting device.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

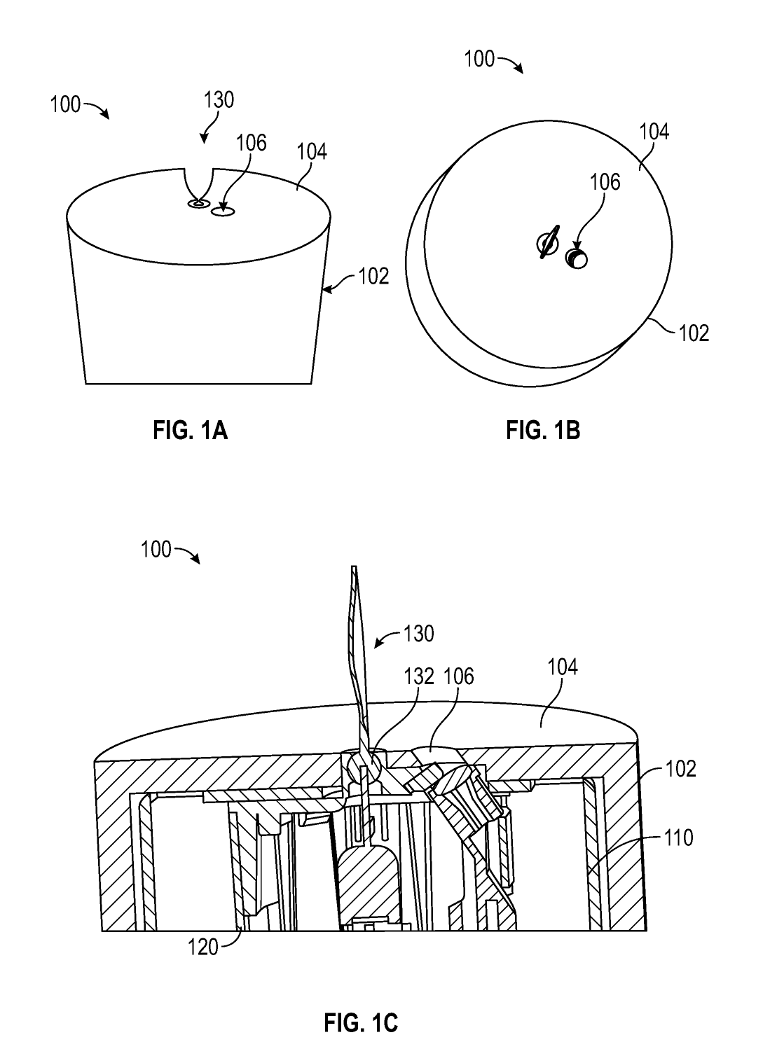

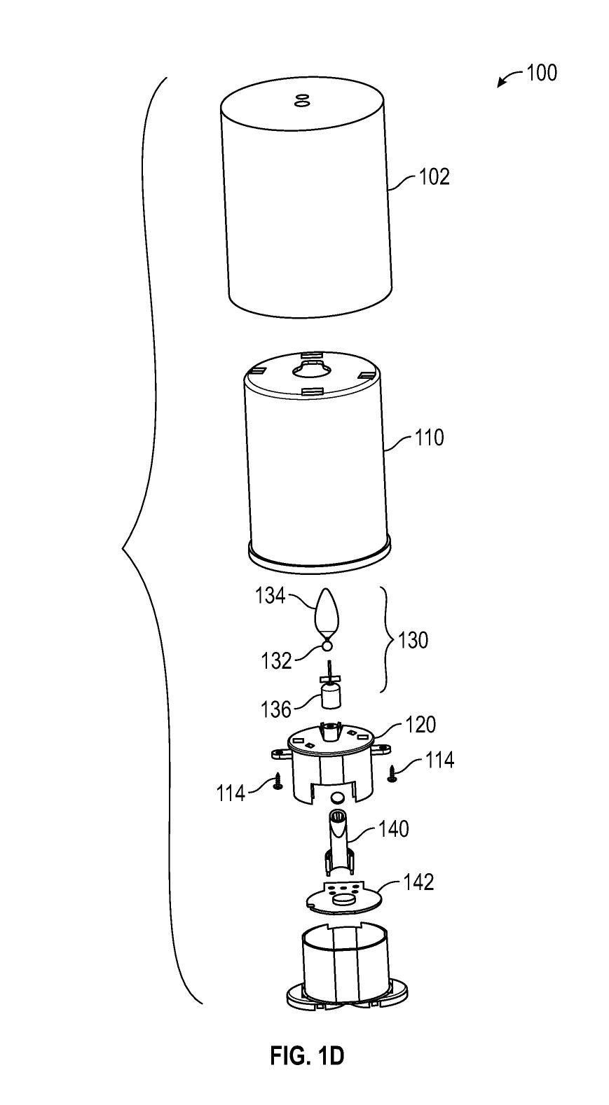

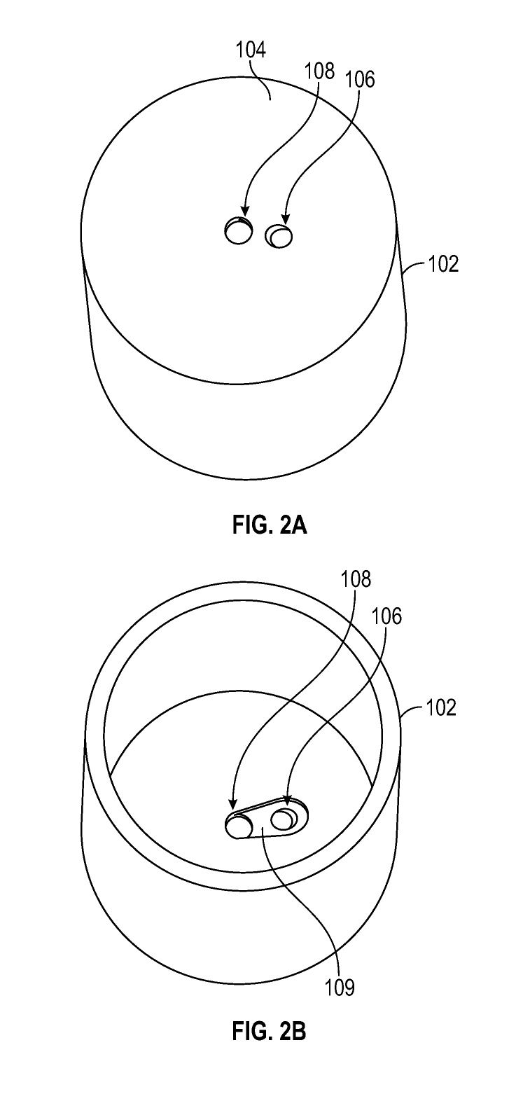

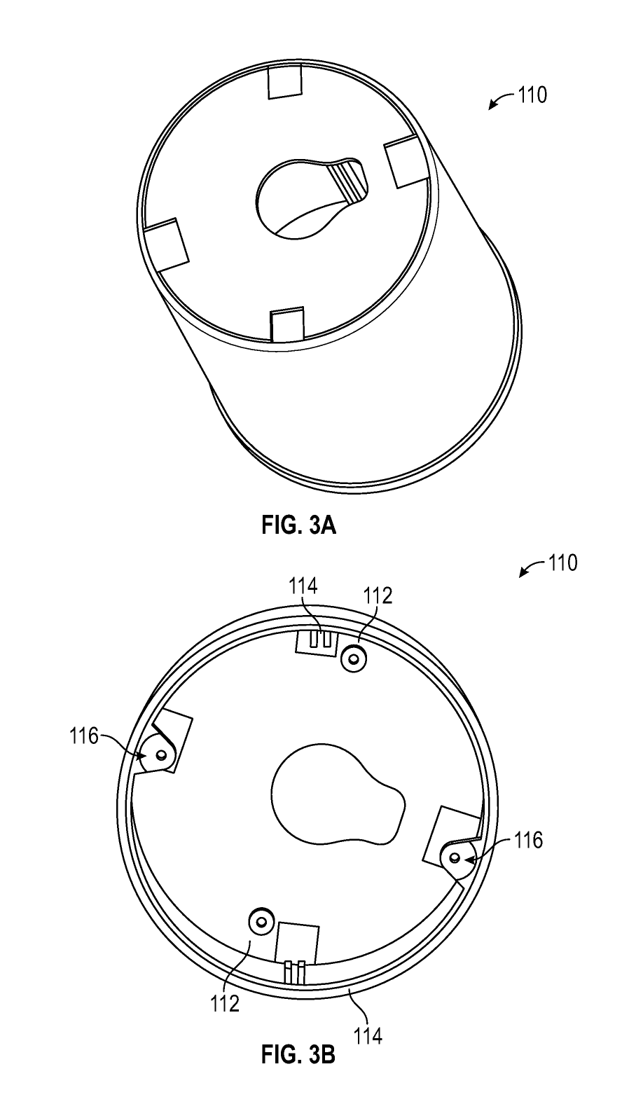

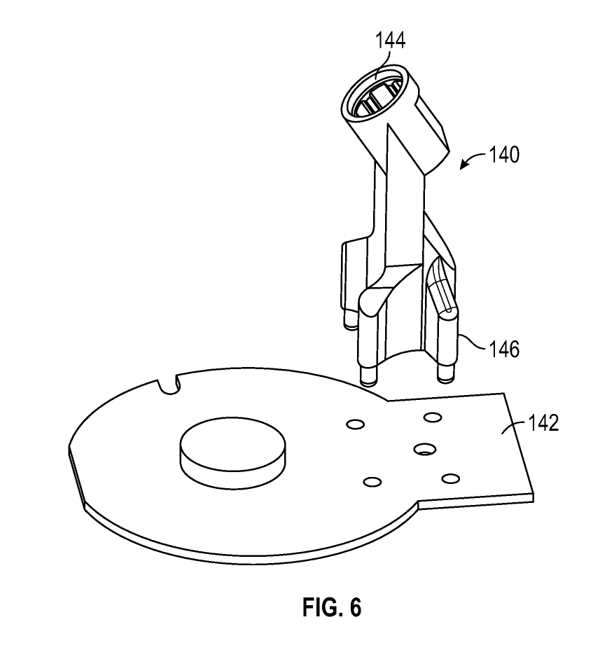

In FIGS. 1A-6, an embodiment of an electric lighting device 100 is shown that is shaped like a traditional, wax candle. The device 100 comprises an outer wax or wax-like shell 102 having an aperture 106 in the upper surface 104 through which light from a light source can be emitted. The upper surface can include a second aperture 108, and in other embodiments described below, could alternatively comprise a divot or recess into which the flame element is mounted. As shown best in FIG. 2B, the bottom of the upper surface preferably comprises a recessed area 109 near or adjacent to the one or more apertures, which can act as a guide to ensure proper installation of housing 130 into the recessed area 109. FIG. 1C shows how the housing 130 is held into the surfaces of that recessed area 109. Preferably, the outer shell 102 comprises a cylindrical shape, but could be differently shaped without departing from the scope of the invention. In one embodiment, the flame element can have a hollow interior.

The outer shell 102 is preferably injection molded using a wax or wax composite. Alternatively, the outer shell 102 could be formed via extrusion or other manners, some of which are described in co-pending application having Ser. No. 15/096,061 filed on Apr. 11, 2016.

The device 100 further comprises an inner shell 110 sized to be disposed within the outer shell 102. The inner shell 110 preferably comprises an injection-molded piece that includes one or more receptors 112 for fasteners. Advantageously, the housing 120 can thereby be secured to the inner shell 110 using fasteners such as screws 114 shown in FIG. 1D, which reduces the amount of internal structure required to support the components utilized to produce the flickering flame effect.

As an alternative embodiment, the inner and outer shells could comprise a single injection molded piece that includes the receptors. This advantageously reduces the overall cost of manufacture and simplifies the assembly process. Further discussion of these concepts can be found in co-pending patent application having Ser. No. 15/096,061 filed on Apr. 11, 2016.

The inner shell 110 can include one or more keyways 115 that can be used to ensure proper alignment of components disposed within the inner shell 110. The inner shell 110 can further include one more receptors 116 for fasteners, which allow for a base of the device 100 to be coupled with the inner shell 110.

A housing 120 can be disposed within the inner shell 110, and configured to support the flame element 130. An upper surface 122 of the housing 120 preferably is shaped to mate with the recessed area 109 of the outer shell 102.

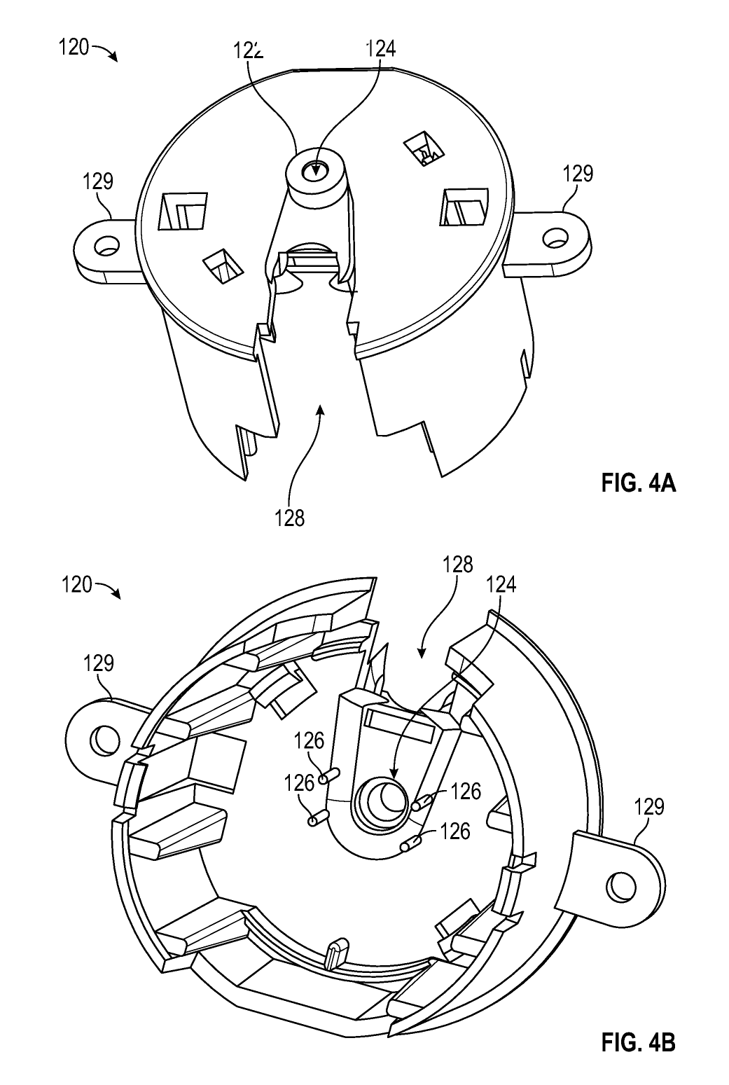

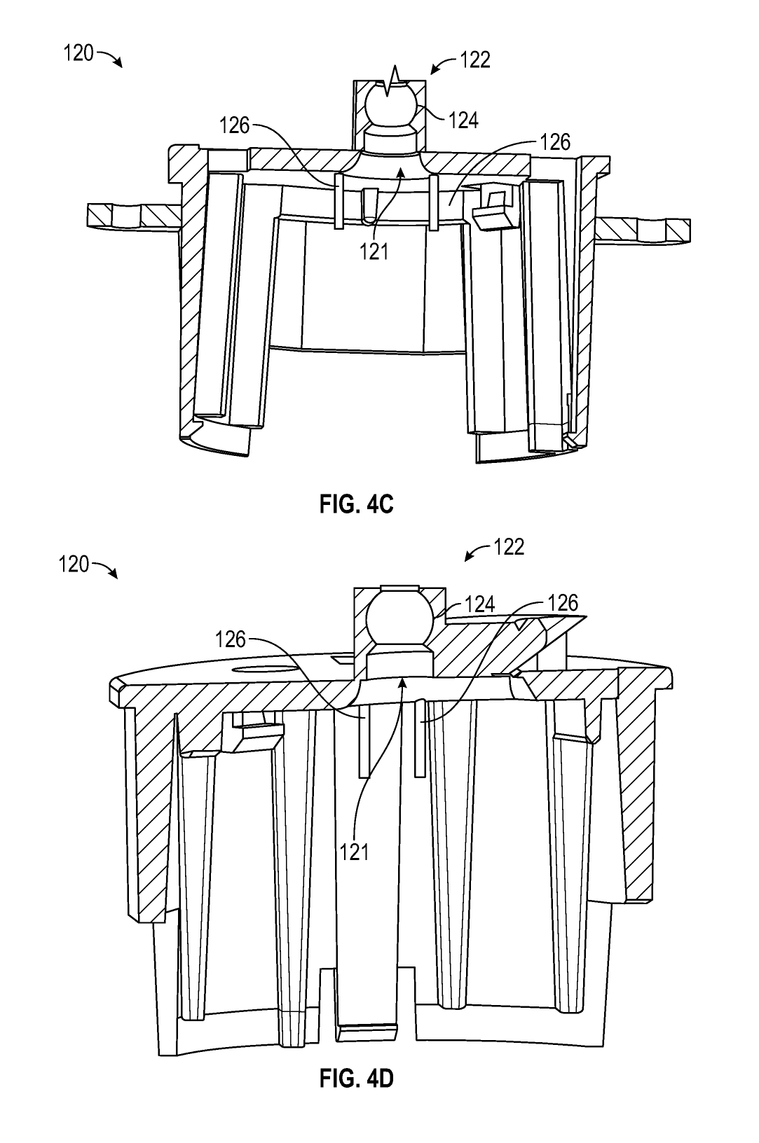

The upper surface 122 preferably comprises a socket or cup 124 configured to receive and support a spherical body (ball) 132 of the flame element 130. The flame element can act as a pendulum member. This is best shown in FIGS. 4C and 4D. Once inserted, the ball 132 can move within the socket 124, which in turns move the flame-shaped portion 134 of the pendulum member 130. To limit movement of the flame element 130 within the housing 120, the housing 120 can include one or more projections 126 that restrict overall movement of the flame member 130 by preventing movement outside a defined area or region. In an alternative embodiment, flexible wires or other material could be used to act as a spring or bias to limit movement of the flame member 130 and supply a force to help return the pendulum member 130 to a steady state position.

It is contemplated that the spherical body 132 can comprise regions having a material with a lower coefficient of friction that the rest of the body 132 such that friction between the body 132 and socket 124 can be reduced. It is also contemplated that the body 132 can include raised portions or bumps that preferably comprise a different material to reduce friction between the body 132 and socket 124.

By using a ball/socket combination, the illusion of a flickering flame is further accented by eliminating a visible hole in the upper surface 104 of the outer shell 102 where the flame member is located and that found in many prior art devices, and concealing the structure that holds the flame member in place and provides for its movement.

The housing 120 can further include a cut-out 128 where a light source can be mounted separately from the housing 120, and preferably be inserted into place once the housing 120 is coupled to the inner shell 110. Housing 120 can also include receptors 129 that align with receptors 112 of the inner shell 110, such that the housing 120 can be coupled to the inner shell 110 using one or more screws 114 or other fasteners.

Flame element 130 preferably comprises upper and lower portions, with the upper portion 134 having a flame-shaped appearance connected to a spherically-shaped lower piece 132 by a thinner middle portion 131. It is contemplated that the middle portion 131 could have a dark color to thereby resemble a wick. The lower portion can include a projection 139 extending from a base 136, with the projection 139 sized and dimensioned to be inserted into the opening 133 of the ball or spherical region 132. It is contemplated that the projection 139 can be secured within the spherically-shaped lower piece 132 via a friction-fit, snap-fit, or be screwed into the lower piece 132, to thereby prevent unintentional disconnection of the upper and lower portions. The flame element 130 is partially housed within the housing 120, such that the flame element 130 is allowed to move in a manner that simulates a moving flame. A detailed description of embodiments of a flame element and housing can be found in co-pending application having Ser. No. 14/819,146.

Preferably, the base 136 of the flame member 130 is sized and dimensioned to be larger in diameter than a diameter of the aperture 121 in the housing 120. In this manner, when the base 136 is coupled to the upper portion, the upper portion is prevented from being removed from the device 100 because the base 136 cannot pass through the aperture 121. Base 136 can also be configured to receive a magnet in recess 137. In this manner, the magnet can interact with a magnetic field generated by an electromagnet, for example, to thereby cause movement of the flame member 130.

Flame member 130 can further include one or more wings 138, which in conjunction with projections 126 or other structure limits movement of the pendulum member 130 with respect to the housing 120.

Device 100 can further include a light source holder 140 that preferably attaches to a circuit board or circuit board cover 142 via support bracings 146 that protrude from the bottom end of the holder's column. The support bracings can be inserted into holes on the board or cover 142. The support bracings are configured to stabilize the column and light source against the circuit board such that the angle and position of the light source advantageously remains stationary once installed. In a preferred embodiment, it is contemplated that the holder 140 can be secured in place via a screw or other fastener(s) to prevent movement of the holder 140 once installed.

The light source holder 140 preferably includes four support bracings that are spread evenly around the column and protrude in different angles from the column. It is contemplated that the column could be attached with any material or mechanism suitable for stabilizing the holder, and it is further contemplated that there could be any number of support bracings. The support bracings preferably have flat bottoms that lay against the circuit board and each support bracing can have a small pin protrusion that can fit in an aperture in the circuit board to provide more stability. It is contemplated that the support bracings and column can be manufactured as a single piece via injection molding. By creating the support bracings and column as a single piece, the overall complexity of the device is significantly reduced. By forming the support bracings and column as a single piece, the number of parts is reduced, simplifying assembly (e.g., by robotic or human assembly lines).

The light source holder 140 preferably comprises a light source, a lens, a column, and support bracings. The column has a bottom end and an angled top end. The angled top end is configured to receive the light source and the lens, and preferably includes a recess 144 to receive and support a lens to direct light from a LED or other light source against the flame-shaped piece 134 of the flame member 130. The angle of the angled end is configured with respect to the flame element 130 to precisely create the effect of a real candle. It is contemplated that the column could be of any shape (e.g., cylindrical, rectangular, etc.). Further discussion concerning the light source holder can be found in co-pending application having Ser. No. 62/267,168 filed on Dec. 14, 2015.

Circuit board 142 can control a drive mechanism, which could be an electromagnet, a fan, or other component that creates kinetic motion on the flame element to simulate the movement of a moving flame.

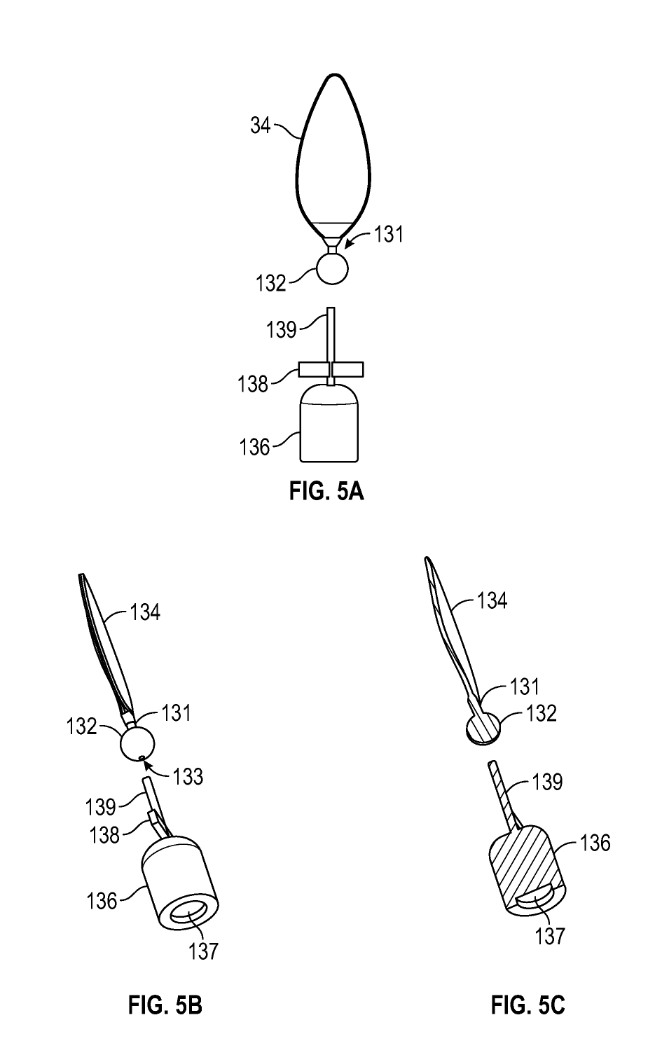

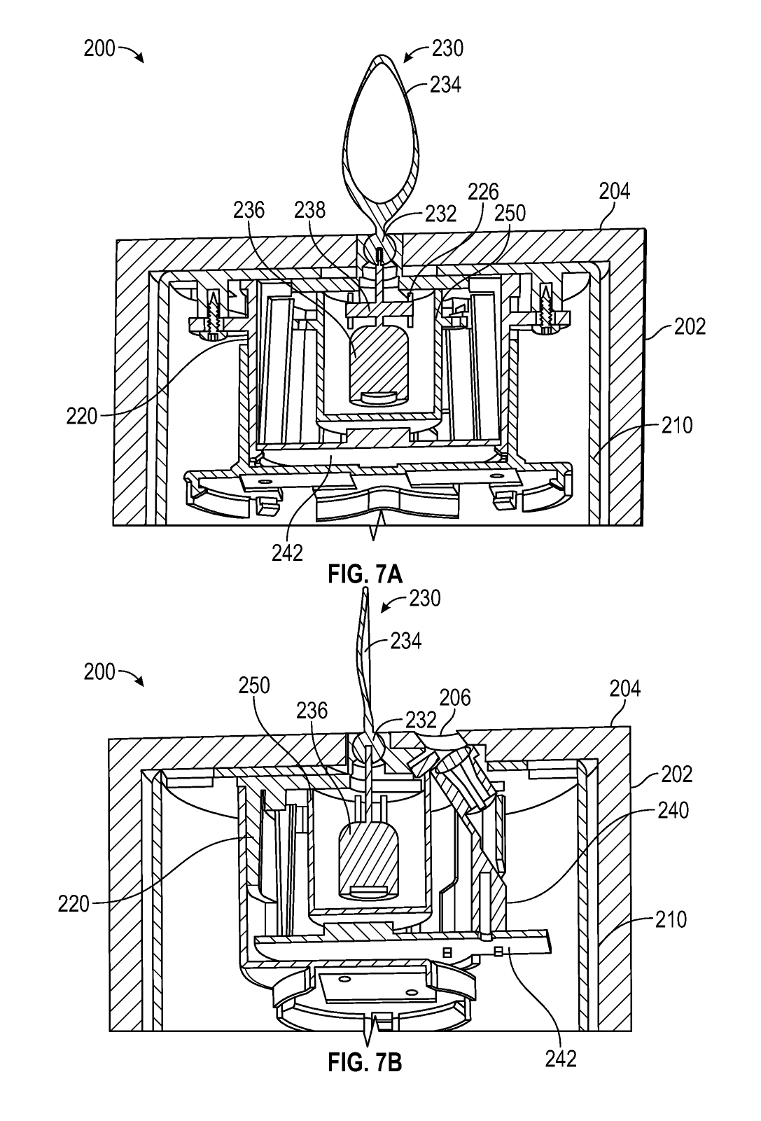

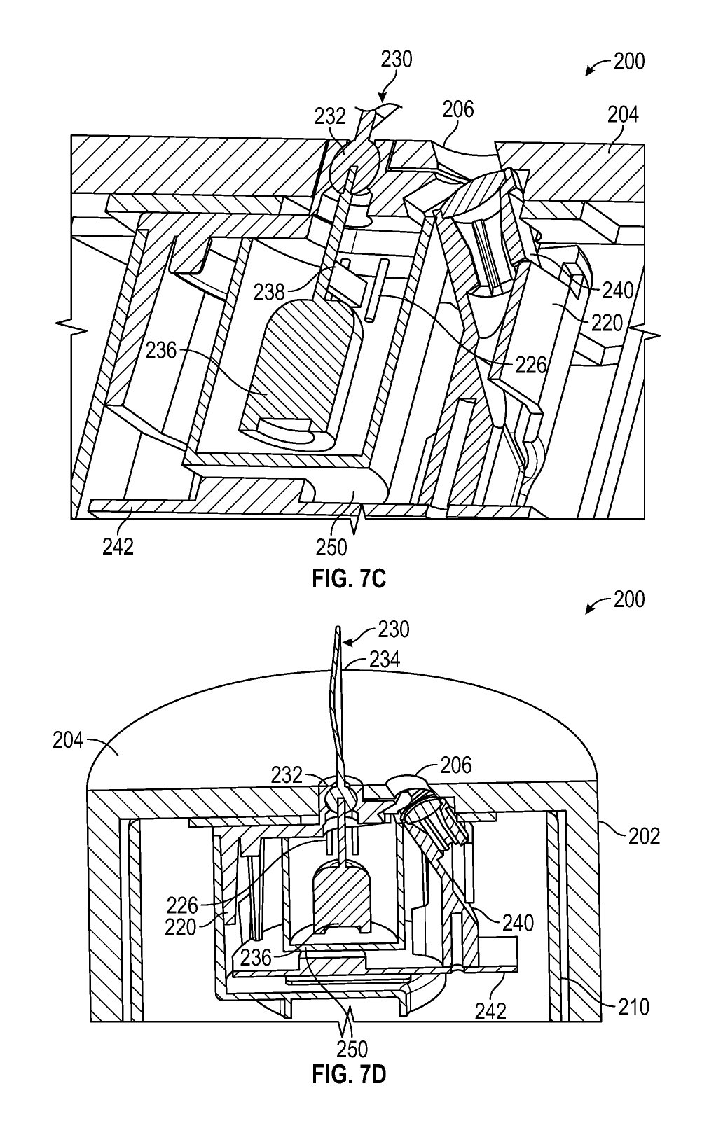

FIGS. 7A-7D illustrate another embodiment of an electric lighting device 200 comprising a cap 250 that is coupled to the housing 220 or shell 202, and configured to encapsulate the base 236 of the flame/pendulum member 230. The cap also holds circuit board 242, which includes a light source mounted on the circuit board. The cap 250 advantageously restricts a motion of the pendulum member 230 while also sealing the aperture in the upper surface 204 of shell 202. It is especially preferred that the cap 250 be affixed to the shell 202 via ultrasonic welding or other commercially suitable manner. In such embodiments, housing 220 could be eliminated as well as inner shell 210. Cap 250 preferably comprises a plastic or other material that will have little to no impact on the magnetic field generated by the electromagnet. In one embodiment shown in FIG. 7A, the flame member 230 can include wings 226, or any of the other projections shown in FIGS. 5A-5C.

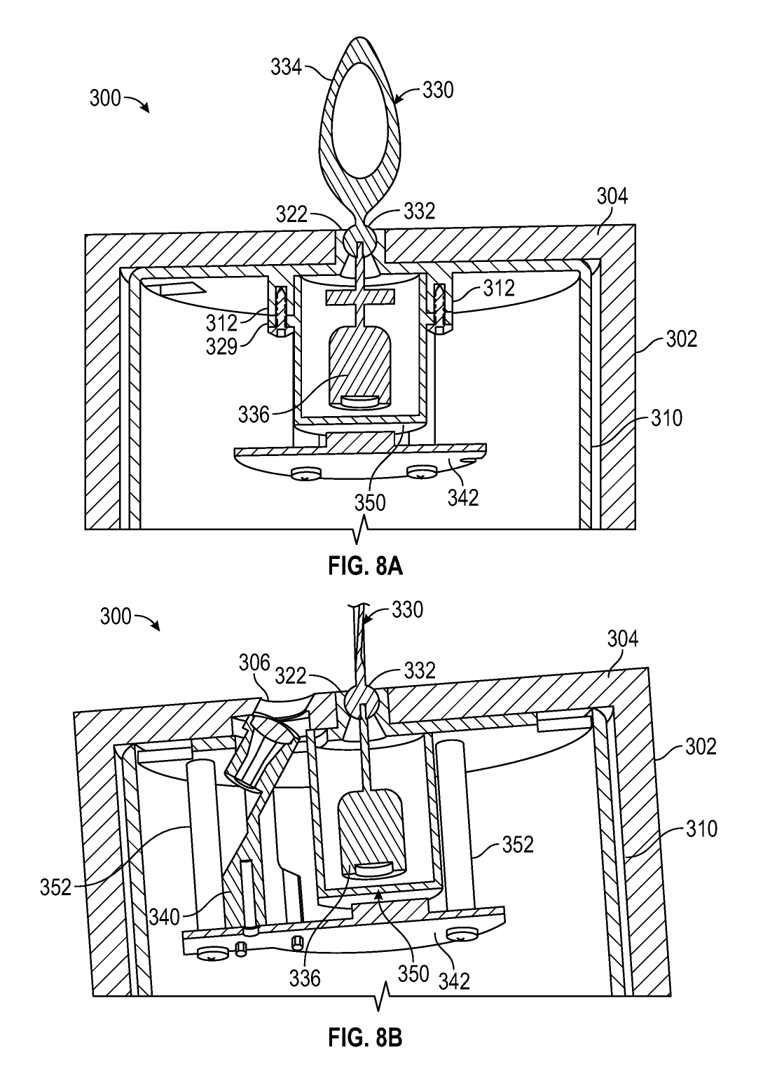

FIGS. 8A-8B illustrate yet another embodiment of an electric lighting device 300, in which the housing has been eliminated. This advantageously reduces the number of components required for manufacture and simplifies assembly of the device 300, thereby reducing overall cost of manufacture. Cap 350 is coupled to the inner shell 310 via fasteners that extend through receptors 329 of the cap 350 and receptors 312 that are integral with the inner shell 310. With the housing eliminated, the circuit board 342 can be coupled to the inner shell via supports 352. Preferably, an electromagnet and light source holder 340 are disposed on the board 342 and supported by inner shell 310. With respect to the remaining numerals in FIGS. 8A-8B, the same considerations for like components with like numerals of FIGS. 1A-1D apply.

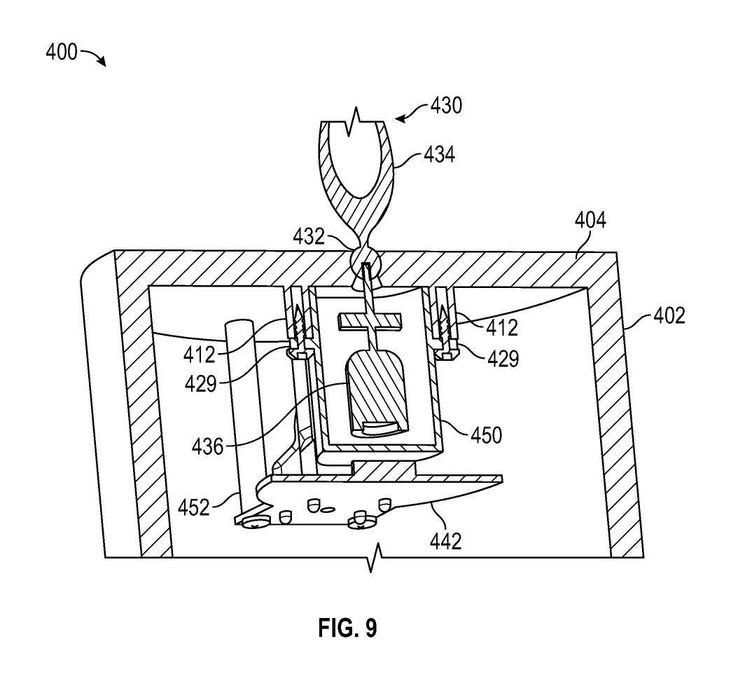

In still further embodiments shown in FIG. 9, both the housing and inner shell can be eliminated from the device 400, leaving the outer shell 402. In such embodiments, it is contemplated that the cap 450 can be attached directly to the outer shell 402 via fasteners that are inserted into receptors 429 and 412. Similarly, the circuit board 442 can be attached to the outer shell 402 via supports 452. With respect to the remaining numerals in FIG. 9, the same considerations for like components with like numerals of FIGS. 1A-1D apply

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Thus, it should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An electric lighting device, comprising:
a light source support configured to receive and support a light source;
a housing comprising an internal cavity, wherein the housing is configured to cover the light source support;
a flame element comprising a first part shaped like a flame, that extends outside the internal cavity, and a connection part that connects to the housing, and where the connection part includes an aperture disposed in the connection part; and
an arm that extends horizontally from the housing and has a first end disposed in the internal cavity, wherein the arm is sized and dimensioned to extend into and connect to the aperture to suspend the flame element relative to the cavity and where movement of the arm in the cavity moves the flame element outside the cavity.

2. The device as in claim 1, wherein the arm is disposed in a central area of the internal cavity.

3. The device as in claim 2, wherein the arm also includes projections, which are located to interact with structure in the housing which prevents the projections from moving beyond a specified amount, and limits an amount of movement of the arm and hence limits an amount of movement of the flame element.

4. The device as in claim 1, further comprising a flame element moving device, which interacts with the flame element to move the flame element.

5. The device as in claim 1, wherein a top surface of the housing includes a flame element receiving aperture, which connects to the connection part in the flame element.

6. The device as in claim 1, wherein said arm includes a magnetic element at a distal portion thereof and further comprising an electromagnet in the housing which causes pendulum like movement of the flame element.

7. The device as in claim 1, further comprising a light source inside the housing the light source having a light output which shines onto a surface of the flame element.

8. An electric lighting device, comprising:
a circuit board, having electronic circuitry thereon;
a support coupled to the circuit board;
a light source support coupled to the circuit board and configured to receive and support a light source;
a housing comprising an internal cavity, wherein the housing is configured to couple to the supports and to hold the supports; and
a flame element coupled to the housing such that the flame element is movable with respect to the housing
and where the light source support faces towards the flame element.

9. The electric lighting device as in claim 8, further comprising a light source mounted in the light source support, shining on a surface of the flame element.

10. The electric lighting device as in claim 9, further comprising at least one circuit on the circuit board, which controls energization of the light source.

11. The electric lighting device as in claim 8, further comprising an electromagnet located on the light source, the electromagnet interacting with the flame element, and causing the flame element to move.

12. The electric lighting device as in claim 11, wherein further comprising at least one circuit on the circuit board which controls energization of the electromagnet to move the flame element.

13. The electric lighting device as in claim 12, further comprising an arm connected to the flame element, the arm extending inside the housing, and wherein said arm includes a magnetic element at a distal portion thereof and where the electromagnet in the housing causes pendulum like movement of the flame element.

14. An electric lighting device, comprising:
a flame member operating to move like a pendulum, having a upper portion having a flame-shaped appearance, and a spherical body portion disposed beneath the upper portion; and
a housing comprising a socket configured to receive the spherical body portion, and to allow the spherical body portion to move within the socket,
wherein the flame member also includes an arm extending from the spherical body portion in it opposite direction from the flame member; and
an arm moving device, in the housing, causing the arm to move and thereby causing the flame member to move.

15. The electric lighting device as in claim 14, further comprising a light source, coupled to said housing, and directing light onto a surface of the flame member.

16. The electric lighting device as in claim 15, further comprising a circuit board, mounted in the housing, wherein the light source is on a holder, and where the holder is connected to the circuit board.

17. The device of claim 14 wherein the arm comprises a first wing configured to restrict movement of the arm of the flame member.

18. The device as in claim 14, wherein a portion on the arm includes a magnet, and further comprising an electromagnet which interacts with the arm to move the flame portion.

19. The device as in claim 16, wherein a portion on the arm includes a magnet, and further comprising an electromagnet, mounted on the circuit board, which interacts with the arm to move the flame portion.
